(19) United States
(12) Patent Application Publication
(10) Pub. No.: US 2017/0143126 A1
(43) Pub. Date: May 25, 2017

(54) Canopy Apparatus for Lawn Chair/Wheel Chairs

(71) Applicant: Albert Wynn, Broadview, IL (US)

(72) Inventor: Albert Wynn, Broadview, IL (US)

(21) Appl. No.: 15/357,806

(22) Filed: Nov. 21, 2016

Related U.S. Application Data
(60) Provisional application No. 62/257,915, filed on Nov. 20, 2015.

(51) Int. Cl. A47C 7/66; A47C 31/11; A61G 5/10; E04H 15/02

(52) U.S. Cl. CPC A47C 7/66; E04H 15/02; A47C 31/113; A61G 5/10

(57) ABSTRACT

A canopy apparatus for protecting a chair is provided. The chair has a pair of vertical supports with one vertical support on each side of a backrest. The canopy apparatus comprises a rigid support frame a canopy covering stretched over the support frame. Upon securing the support frame to the chair, the canopy covering ensures adequate protection from the elements, particularly harsh sunlight and inclement weather conditions.

### CLAIM OF PRIORITY

This patent application claims priority under 35 USC 119 (e) (1) from U.S. Provisional Patent Application Ser. No. 62/257,915 filed Nov. 20, 2015, of common inventorship herewith entitled, “Canopy for Lawn Chairs and Wheel Chairs,” which is incorporated herein by reference as though the same were set forth in its entirety.

### FIELD OF THE INVENTION

The present invention pertains to the field of outdoor accessories, and more specifically to the field of canopy attachments for lawn chairs and wheel chairs.

### BACKGROUND OF THE INVENTION

For millions of people, a popular pastime is spending time outdoors. Whether a father and son spending a lazy afternoon fishing for bass, a young couple enjoying a holiday parade or a soccer mom cheering her child on to victory, outdoor activity is an integral part of life for many people. Countless workers spend their work days behind desks, in cars or trucks, or working in mills and factories. For them, sunshine and the smell of grass can be a refreshing change from closed in spaces and artificial light. Perhaps this is why so many people choose to spend their free time in the fresh air attending sporting events, going on an overnight campouts, or lounging in the sunshine with a good book. Revitalizing the body, mind and spirit, time spent outside is a wonderful and relaxing way to spend any day.

Although time spent in fresh air is exhilarating, an unfortunate reality is that Mother Nature sometimes refuses to cooperate with one's scheduled activities. Rain, wind and hail, all function to put a damper on a planned afternoon outdoors. Many sporting events such as little league games, pee wee football scrimmages and soccer matches are typically played regardless of weather conditions, parents and sports fans often endure harsh elements to support their favorite player or team. On sunny afternoons, outdoor enthusiasts contend with dangers of overexposure to the sun as well as excessive heat associated with sitting directly in the sun for extended periods. The prior art has put forth several designs for canopy attachments. Among these are:

U.S. Pat. No. 5,080,432 to Brian J. Connell describes a canopy attachment for a lawn chair, notably of the folding type. The canopy attachment has a frame mountable on the chair by means of a detachable connection to the cross rod that appears in the chair at the junction of the chair seat and seat back. The canopy frame is made up of a plurality of relatively foldable parts for compact disposition when detached from the chair. In addition to the detachable connection to the cross member of the chair, the canopy support frame has a further connection to the chair in upwardly spaced relation to the cross member, plus a roof projecting forwardly from the upper end of the support.

U.S. Pat. No. 4,201,416 to Robert D. Vanderminden describes a canopy construction for collapsible outdoor furniture. U shaped clamps which secure the canopy to the chair are constructed with a reversely bent leg to prevent pivoting of the canopy towards the front of the chair. Each clamp is made of a one piece metal blank which is shaped to fit over the chair frame and to receive a canopy leg.

U.S. Pat. No. 3,243,230 to Eugene Otto describes a sun shade for folding chair comprising in combination a seat including a rear tie bar and a back including a top tie bar. A pair of laterally disposed vertical support rods are pivotally connected at their lower ends to said seat tie bar. A means on said top tie bar of the back section slidingly supports said support rods for vertical relative sliding movement thereon. A back shade portion is pivotally mounted for swinging movement about a horizontal axis on the upper ends of said support rods. A top shade portion is pivotally mounted at its rear portion on the top portion of said back shade portion and extendable over said chair back and seat.

None of these prior art references describe the present invention.

### SUMMARY OF THE INVENTION

It is an object of the present invention to provide a canopy that is configured to be easily applied to an existing lawn chair or wheelchair and ensure adequate protection from the elements, particularly harsh sunlight and inclement weather conditions.

The present invention is a canopy apparatus for protecting a chair. The chair has a pair of vertical supports with one vertical support on each side of a backrest. The canopy apparatus comprises a rigid support frame a canopy covering stretched over the support frame. Upon securing the support frame to the chair, the canopy covering ensures adequate protection from the elements, particularly harsh sunlight and inclement weather conditions.

In addition, the present invention includes a method for protecting a chair. The chair has a pair of vertical supports with one vertical support on each side of a backrest. The method comprises providing a rigid support frame, stretching a canopy covering over the support frame, securing the support frame to the chair, and providing adequate protection from the elements, particularly harsh sunlight and inclement weather conditions.

The present invention further includes a canopy apparatus for protecting a chair. The chair has a pair of vertical supports with one vertical support on each side of a backrest. The canopy apparatus comprises a single-piece rigid support frame comprising a first vertical member, a first horizontal member extending from the first vertical member, a second vertical member, a second horizontal member extending from the second vertical member, and a front cross rod extending between the first horizontal member and the second vertical member. A weather resistant, UV blocking material canopy covering is stretched over the support frame. Upon securing the support frame to the chair, the canopy covering ensures adequate protection from the elements, particularly harsh sunlight and inclement weather conditions.

### BRIEF DESCRIPTION OF THE DRAWINGS

FIG. 1 is a front perspective view of a canopy apparatus for lawn chairs and wheel chairs, constructed in accordance with the present invention, with the canopy apparatus attached to a lawn chair, showing a support frame and a canopy covering.

FIG. 2 is a rear perspective view illustrating the canopy apparatus for lawn chairs and wheel chairs, constructed in accordance with the present invention, with the canopy apparatus attached to a lawn chair, showing the support frame, the canopy covering, and a connecting support rod connecting the support frame to the lawn chair.

FIG. 3 is a perspective view illustrating the canopy apparatus, constructed in accordance with the present invention, with the canopy apparatus unattached from a chair and showing the support frame and canopy covering.

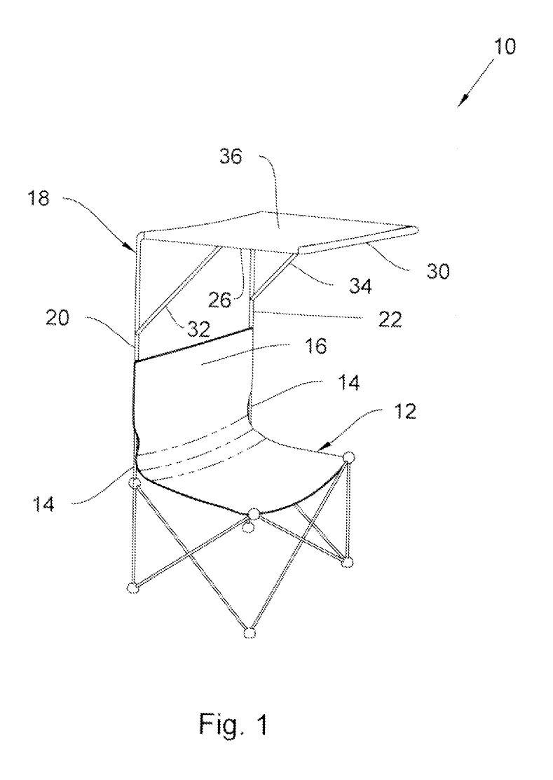

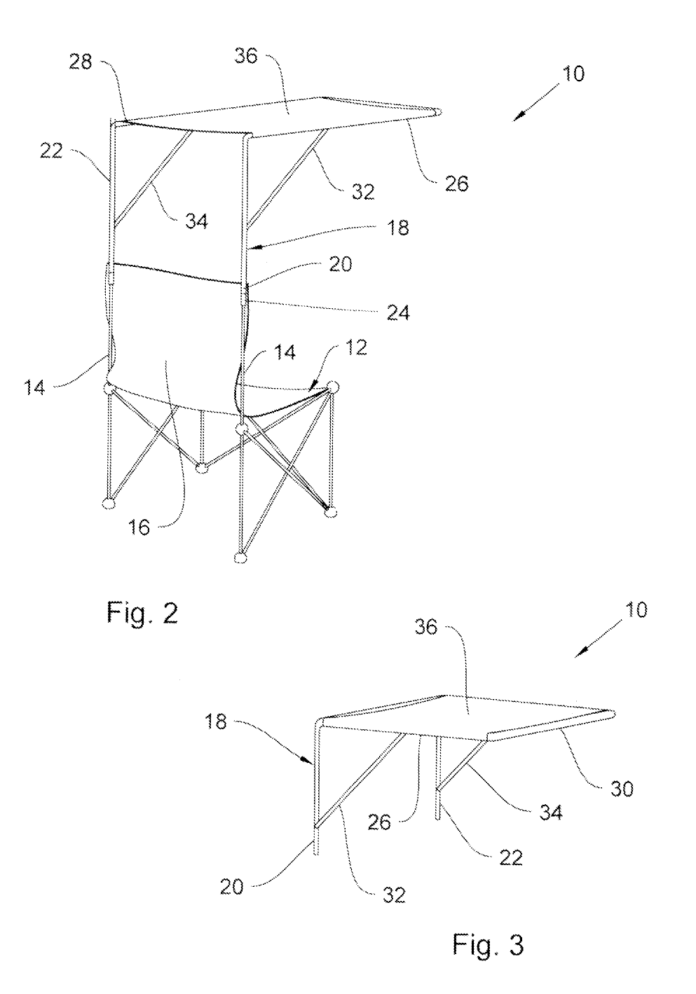

### DETAILED DESCRIPTION OF THE INVENTION

The present invention, hereinafter referred to as a Canopy Apparatus for Lawn Chairs and Wheel Chairs, indicated generally at 10, is a portable awning configured to be easily mounted to an existing lawn chair 12 or wheelchair. While the Canopy Apparatus 10 can be used for both lawn chairs 12 and wheel chairs, the present application will discuss the Canopy Apparatus 10 as it relates to lawn chairs 12. The Canopy Apparatus 10 provides outdoor enthusiasts with a practical enhancement for their seating which ensures adequate protection from the elements, particularly harsh sunlight and inclement weather conditions.

The lawn chair 12 for use with the Canopy Apparatus 10 of the present invention has a pair of vertical supports 14 on each side of a backrest 16 of the lawn chair 12. The vertical supports 14 of the lawn chair 12 support the backrest 16 of the lawn chair 12 while in use by a user.

The Canopy Apparatus 10 of the present invention includes a lightweight and rigid support frame 18. The support frame 18 has a first vertical member 20 having a first end and a second end. The first end of the first vertical member 20 is releasably secured to one of the vertical 14 supports of the lawn chair 12. The support frame 18 further has a second vertical member 22 having a first end and a second end. The first end of the second vertical member 22 is releasably secured to the other vertical support 14 of the lawn chair 12. Preferably, the first vertical member 20 is substantially parallel to the second vertical member 22.

In an embodiment of the Canopy Apparatus 10 of the present invention, the first vertical member 20 and the second vertical member 22 are hollow tubes attached to the backrest 16 of the existing chair 12 by means of simple spring loaded clamps or comparable fasteners, providing a secure and reliable hold during use. Perpendicularly attached to the rear of the support frame 18 and positioned on each side of the Canopy Apparatus 10 is a vertical support post 24 configured expressly to be attached to each end of the backrest 16 of the existing chair 12.

In addition, the support frame 18 of the Canopy Apparatus 10 of the present invention includes a first horizontal member 26 having a first end and a second end. The first end of the first horizontal member 26 is connected to the second end of the first vertical member 20 and preferably extends substantially perpendicular from the first vertical member 20. The support frame 18 further includes a second horizontal member 28 having a first end and a second end. The first end of the second horizontal member 28 is connected to the second end of the second vertical member 22 and preferably extends substantially perpendicular from the second vertical member 22. Preferably, the first horizontal member 26 is substantially parallel to the second horizontal member 28.

Additionally, the support frame 18 of the Canopy Apparatus 10 of the present invention further includes a front cross member 30 having a first end and a second end. The first end of the front cross member 30 is connected to the second end of the first horizontal member 26 and preferably extends substantially perpendicular to both the first horizontal member 26 and the first vertical member 20. The second end of the front cross member 30 is connected to the second end of the second horizontal member 28 and preferably extends substantially perpendicular to the second horizontal member 28 and the second vertical member 22.

Furthermore, the support frame 18 of the Canopy Apparatus 10 of the present invention includes a first diagonal support 32 extending between the first vertical member 20 and the first horizontal member 26 and a second diagonal support 34 extending between the second vertical member 22 and the second horizontal member 28. The first diagonal support 32 has a first end and a second end and the second diagonal support 34 has a first end and a second end. Preferably, the first end of the first diagonal support 32 is secured to the first vertical member 20 at a point approximately halfway between the first end and the second end of the first vertical member 20 and the second end of the first diagonal support 32 is secured to the first horizontal member 26 at a point approximately halfway between the first end and the second end of the first horizontal member 26. Preferably, the first end of the second diagonal support 34 is secured to the second vertical member 22 at a point approximately halfway between the first end and the second end of the second vertical member 22 and the second end of the second diagonal support 34 is secured to the second horizontal member 28 at a point approximately halfway between the first end and the second end of the second horizontal member 28. While it is within the scope of the present invention to secure the first diagonal support 32 and the second diagonal support 34 anywhere along the first vertical member 20 and the first horizontal member 26 and the second vertical member 22 and the second horizontal member 28, by securing the first diagonal support 32 and the second diagonal support 34 as described provides more strength in holding a canopy covering 36, as will be described in further detail below.

It should be noted that while the first vertical member 20 has been described as being connected to the first horizontal member 26, the second vertical member 22 has been described as being connected to the second horizontal member 28, and the front cross member 30 has been described as being connected between the first horizontal member 26 and the second horizontal member 28, it is within the scope of the present invention for the first vertical member 20, the first horizontal member 26, the second vertical member 22, the second horizontal member 28, and the front cross member 30 to be constructed from a single piece of aluminum or plastic tubing and bent to create the support frame 18.

The Canopy Apparatus 10 of the present invention further includes the weather resistant canopy covering 36 stretched over the support frame 18. Preferably, the canopy covering 36 is fabricated with a UV blocking material that inhibits stringent ultraviolet rays of the sun, creating a cool atmosphere for one seated in the chair 12. Preferable material used in manufacturing of the canopy covering 36 includes, but is not limited to, a durable canvas, nylon, and/or woven plastic material. The canopy covering 36 can be produced in a variety of vibrant colors and printed patterns, as well as understated neutral hues. An ample, rectangular shaped canopy covering 36, the canopy covering 36 extends over the top of the chair 14 with measurements of approximately twenty seven (27″) inches in length and nineteen (19″) inches in width.

Use of the Canopy Apparatus 10 of the present invention for Chairs is very simple and straight forward. The Canopy Apparatus 10 is easily toted to outdoor events such as tailgate parties, backyard barbecues, and little league games. In the event of excessive sunshine or heat, the Canopy Apparatus 10 is utilized to create a shaded oasis over one's chair 12. The Canopy Apparatus 10 also is utilized to protect a user from rain, sleet and other inclement weather. Application of the Canopy Apparatus 10 simply involves positioning the rectangular canopy covering 36 of the Canopy Apparatus 10 directly over the top of the lawn chair 12 or wheel chair and securing its two vertical support posts 24 to each end of the top of the chair's backrest 16, utilizing the clamps or comparable fasteners located on the base of each support post 24 to mount the canopy covering 36 in place. Thus installed, the Canopy Apparatus 10 encompasses the total area above the chair 12. After use, the Canopy Apparatus 10 is removed from the chair 12 and stored away along with other outdoor gear until again needed.

Easily storable, the Canopy Apparatus 10 of the present invention is neatly stowed away along with other outdoor accessories, providing quick and easy access whenever needed. An easily applied protective awning for use with virtually any lawn chair 12 or garden chair, the Canopy Apparatus 10 is effectively functional in any outdoor environment. Durably constructed of high quality materials, the Canopy Apparatus 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A canopy apparatus for protecting a chair, the chair having a pair of vertical supports with one vertical support on each side of a backrest, the canopy apparatus comprising:
a rigid support frame; and
a canopy covering stretched over the support frame;
wherein upon securing the support frame to the chair, the canopy covering ensures adequate protection from the elements, particularly harsh sunlight and inclement weather conditions.

2. The canopy apparatus of claim 1 wherein the support frame comprises:
a first vertical member;
a first horizontal member extending from the first vertical member;
a second vertical member;
a second horizontal member extending from the second vertical member; and
a front cross rod extending between the first horizontal member and the second vertical member.

3. The canopy apparatus of claim 2 wherein the first vertical member is releasably securable to one of the vertical supports of the chair and wherein the second vertical member is releasably securable to the other vertical support of the chair.

4. The canopy apparatus of claim 2 wherein the first vertical member is substantially parallel to the second vertical member.

5. The canopy apparatus of claim 4 wherein the first horizontal member is substantially perpendicular to the first vertical member, wherein the second horizontal member is substantially perpendicular to the second horizontal member, and wherein the first vertical member is substantially parallel to the second horizontal member.

6. The canopy apparatus of claim 5 wherein the front cross rod is substantially perpendicular to the first vertical member, the second vertical member, the first horizontal member, and the second horizontal member.

7. The canopy apparatus of claim 3 wherein the first vertical member and the second vertical member are hollow tubes attached to the backrest by a spring loaded clamp.

8. The canopy apparatus of claim 2 and further comprising:
a first diagonal support extending between the first vertical member and the first horizontal member; and
a second diagonal support extending between the second vertical member and the second horizontal member.

9. The canopy apparatus of claim 8 wherein the first diagonal support is secured to the first vertical member at an approximate mid-point of the first vertical member and at an approximate mid-point of the first horizontal member and wherein the second diagonal support is secured to the second vertical member at an approximate mid-point of the second vertical member and at an approximate mid-point of the second horizontal member.

10. The canopy apparatus of claim 2 wherein the first vertical member, the first horizontal member, the second vertical member, the second horizontal member, and the front cross member are constructed from a single piece material.

11. The canopy apparatus of claim 10 wherein the material is selected from the group consisting of aluminum tubing and plastic tubing.

12. The canopy apparatus of claim 1 wherein the canopy covering is constructed from a weather resistant, UV blocking material.

13. The canopy apparatus of claim 12 wherein the material is selected from the group consisting of canvas, nylon, and woven plastic material.

14. A method for protecting a chair, the chair having a pair of vertical supports with one vertical support on each side of a backrest, the method comprising:
providing a rigid support frame;
stretching a canopy covering over the support frame;
securing the support frame to the chair; and
providing adequate protection from the elements, particularly harsh sunlight and inclement weather conditions.

15. A canopy apparatus for protecting a chair, the chair having a pair of vertical supports with one vertical support on each side of a backrest, the canopy apparatus comprising:
a single-piece rigid support frame comprising:
a first vertical member;
a first horizontal member extending from the first vertical member;
a second vertical member;
a second horizontal member extending from the second vertical member; and
a front cross rod extending between the first horizontal member and the second vertical member; and
a weather resistant, UV blocking material canopy covering stretched over the support frame;
wherein upon securing the support frame to the chair, the canopy covering ensures adequate protection from the elements, particularly harsh sunlight and inclement weather conditions.

16. The canopy apparatus of claim 15 wherein the first vertical member is releasably securable to one of the vertical supports of the chair and wherein the second vertical member is releasably securable to the other vertical support of the chair.

17. The canopy apparatus of claim 15 wherein the first vertical member is substantially parallel to the second vertical member, wherein the first horizontal member is substantially perpendicular to the first vertical member, wherein the second horizontal member is substantially perpendicular to the second horizontal member, wherein the first vertical member is substantially parallel to the second horizontal member, and wherein the front cross rod is substantially perpendicular to the first vertical member, the second vertical member, the first horizontal member, and the second horizontal member.

18. The canopy apparatus of claim 3 wherein the first vertical member and the second vertical member are hollow tubes attached to the backrest by a spring loaded clamp.

19. The canopy apparatus of claim 15 and further comprising:
a first diagonal support extending between the first vertical member and the first horizontal member; and
a second diagonal support extending between the second vertical member and the second horizontal member.

20. The canopy apparatus of claim 19 wherein the first diagonal support is secured to the first vertical member at an approximate mid-point of the first vertical member and at an approximate mid-point of the first horizontal member and wherein the second diagonal support is secured to the second vertical member at an approximate mid-point of the second vertical member and at an approximate mid-point of the second horizontal member.
